(19) United States
(12) Patent Application Publication
(10) Pub. No.: US 2010/0078194 A1
(43) Pub. Date: Apr. 1, 2010

(54) Polymeric compositions containing nanotubes

(76) Inventors: Sandeep Bhatt, Boxford, MA (US); Jean-Michel Poncelet, Sprimont (BE); Vincenzo Taormina, Seraing (BE)

Correspondence Address: Robert J. Follett, Esq.;CABOT CORPORATION, Billerica Technical Center, 157 Concord Road, Billerica, MA, 01821-7001, US

(21) Appl. No.: 11/500,267

(22) Filed: Aug. 7, 2006

Related U.S. Application Data
(60) Provisional application No. 60/706,469, filed on Aug. 8, 2005.

(51) Int. Cl. H01B 3/30; H01B 1/24; B05D 5/12; B32B 1/08; B05D 1/04

(52) U.S. Cl. 174/110 SR; 252/511; 427/458; 428/35.7; 977/750; 977/932

(57) ABSTRACT

A polymeric composition containing at least one polymer and carbon nanotubes is described. The polymeric composition can have carbon nanotubes that are multi-wall carbon nanotubes and/or single-wall carbon nanotubes. The compositions can also contain carbon black. Also described are various articles made from the polymeric compositions including cables and other articles.

This application claims the benefit under 35 U.S.C. §119(e) of prior U.S. Provisional Patent Application No. 60/706,469, filed Aug. 8, 2005, which is incorporated in its entirety by reference herein.

### BACKGROUND OF THE INVENTION

The present invention relates to carbon nanotubes in various compositions, and further relates to their use in wire and cable compounds, such as shielding compositions. The present invention also relates to incorporating blends of carbon nanotubes and carbon blacks into wire and cable compounds and achieving certain properties by use of the aforementioned blends.

Insulated cable is used extensively for transmission and distribution of electrical power. Two components of the power cable can contain conductive carbon black, the strand shield and insulation shield. Semi-conductive materials are used to create an equipotential surface between the conductor and the insulation.

Conductive fillers can be incorporated into the polymer composition through a variety of mixing techniques. The degree of electrical conductivity imparted by specific fillers is related to their physical and chemical properties. For fillers with the desired conductivity, it is generally desirable to utilize those conducting fillers that will provide as low a viscosity as possible, and thus improve the processability of the polymer composition of the mixture. For cable applications, another important factor affecting extended cable life is smoothness at the shield interfaces. Any defect at the interfaces can increase the stress levels and may lead to premature cable failure.

The power cables designed for medium to high voltage applications can have a copper or aluminum core conductor, a layer of semi-conductive shielding, a layer of insulation, and a layer of semi-conductive insulation shielding. The insulation layer can be predominantly either crosslinked polyethylene or crosslinked ethylene propylene rubber (EPR). During the installation of the cable it is often necessary to make splices and terminal connections, and this requires the clean delamination of the insulation shield layer from the insulation layer. Therefore, a strippable semi-conductive insulation shielding which can be easily stripped from the insulation layer is desirable. However, a minimum strip force is required to maintain the mechanical integrity between the insulation layer and the semi-conductive insulation; if the force is too low then loss of adhesion may result in water diffusing along the interface causing electrical breakdown.

Accordingly, it will be advantageous to produce novel compositions that can impair, at the same time, higher compound conductivity, at a comparatively lower viscosity, and high level of smoothness and a low adhesion in strippable formulations. These and other advantages can be achieved by the compositions of the present invention.

Electrostatic charge buildup is the cause of a variety of problems for many different technologies. Electrostatic charging can cause materials to stick together, or to repel one another. Charge buildup can also attract dirt and other foreign particles and cause them to stick to the material. Electrostatic discharges from insulating objects can also cause serious problems in a number of technology areas. For example, when flammable vapors are present, an electric discharge can ignite the vapors causing explosions and fires.

Static charge buildup is a particular problem in the electronics industry, since modern electronic devices are extremely susceptible to damage by static discharges. Static charge buildup is also a particularly serious problem in automotive applications, where flammable vapors are present. This includes tubes, fuel lines and other plastic automotive parts, where electrostatic charge can develop.

Static charge buildup can be controlled by increasing the electrical conductivity of the material. Most antistatic agents operate by dissipating static charge as it builds up. Static decay rate and surface conductivity are common measures of the effectiveness of antistatic agents.

Antistatic agents can be incorporated into the bulk of an otherwise insulating material. Indeed, conductive fillers are commonly employed as antistatic agents in polymers. However, relatively few conductive fillers have the requisite thermal stability to withstand polymer melt processing temperatures, which can be as high as 250° C. to 400° C. or more. It is also generally desirable to utilize as low of a loading of filler as possible, so as to not compromise the physical properties of the material.

In the case of conductive fillers such as carbon black and metal powders, a large amount of carbon black or the metal powders must be used with the matrix material. This results in a deterioration of fluidity at the extrusion molding step, and makes it difficult to obtain a sheet having satisfactory properties. In addition, the mechanical strength, and particularly the impact strength, of the resultant sheet material is reduced to an extent that makes it unsatisfactory for practical uses. Nevertheless, the dissipation of the static charge may be greatly improved.

Accordingly, for antistatic dissipation applications, it is desirable to develop a conductive filler that imparts conductivity at a relatively low loading of filler. Carbon black has a high percolation threshold, and generally requires a high loading. A conductive filler that has a low percolation threshold is needed for this application.

It is also known that the thermal and the flammability characteristics of a host polymer can be affected by the addition of conductive fillers such as carbon black. This has been demonstrated in several publications. See Kashiwagi et al., Polymer 45 (2000) 4227-4239; Beyer G., Fire and Materials 26 (2002) 291-293. These publications are each incorporated herein by reference in their entirety.

Most plastics, as they are organic materials, have a very high degree of flammability. It is desirable in many applications to reduce the flammability of these materials. In some instances strict regulations are in force regarding the flammability characteristics for plastics that are used for certain purposes. This is particularly true in the European Union.

It is desirable to develop fire retardant additives that are environmentally friendly. Fire retardant additives that can be dispersed directly into the polymer without the use of treatments on their surface, or that require compatabilizing polymer modifiers is also needed. Thus, it is desirable to develop conductive filler compositions that improve the flammability characteristics and general thermal properties of a host polymer.

Filler materials, like carbon black, are also known to be capable of improving the mechanical properties of a host polymeric system as well. In particular, advanced materials that are combinations of plastics with other materials, are finding more and greater uses across many industries. It is desirable to develop advanced materials that have greater physical properties such as stiffness, toughness and strength. These materials will find use as in structural sections, I-beams, the structural components of batteries, armor, and in aircraft and in space vehicles.

Also, it is desirable to develop alternatives to filler compositions for tire applications, particularly for high performance tire and racing applications. Currently, primarily carbon black is in use. However, high performing alternatives are currently being developed and are needed. These tires have improved tread performance, improved wear, lower rolling resistance, lower heat build-up, improved tear resistance. The compositions could be from entirely new filler materials or filler compositions that are made from blends with carbon black.

In addition, it is desirable to develop compositions that utilize highly ordered, and/or self-assembled carbon nanotube compositions. Highly ordered self assembled carbon nanotubes are known to possess extremely unusual and remarkable properties. See U.S. Pat. No. 6,790,425 to Smalley et al., incorporated herein by reference in its entirety. Compositions formed from self-assembled carbon nanotube compositions can have remarkable physical, electrical, and chemical properties.

### SUMMARY OF THE INVENTION

The present invention relates to carbon nanotube filled polymeric compositions that can be used for a variety of applications, including but not limited to, electric cables, static dissipation, automotive applications, and applications where a conductive polymeric composition is needed. The carbon nanotube can be used as a filler, either alone, or in blends with other fillers such as carbon black.

A feature of the present invention is to provide novel carbon nanotube compositions which preferably provide one or more improved properties to the wire and/or cable compounds.

Another feature of the present invention is to provide carbon nanotube compositions, which when incorporated into wire and cable compounds, provide a low viscosity.

In addition, a feature of the present invention is to provide carbon nanotube compositions, which when incorporated into wire and cable compounds, leads to acceptable and higher conductivity ranges.

A further feature of the present invention is to provide carbon nanotube compositions, which when incorporated into wire and cable compounds promote a high smoothness of the formed compound.

An additional feature of the present invention is to provide carbon nanotube compositions, which when incorporated into wire and cable compounds, promote a very good stripability of the layer containing the carbon nanotube composition.

Also, a feature of the present invention is to provide carbon nanotube compositions, which when incorporated into wire and cable compounds, provides a combination of all of the above-described properties.

It is another feature of the present invention to provide carbon nanotube compositions with relatively low percolation thresholds of conductive filler; which compositions will find use in the electronics and automotive industries as anti-static plastics. These materials will have a relatively high static decay rate, but will use relatively low loadings of conductive filler, and will preserve a relatively high degree of the host polymer physical properties.

It is another feature of the present invention to provide carbon nanotube compositions that will find use as anti-static agents for use in fuel lines in vehicles.

It is another feature of this invention to provide carbon nanotube compositions that will find use as anti-static agents for polymeric materials that are used in the manufacture of electronic components that are highly sensitive to static discharges.

The present invention further relates to an article, such as an automotive article, like a component of an automotive fuel system or an article which is electrostatically painted, containing one or more of the polymer compositions described above. The present invention further relates to a method of electrostatic painting of an article.

It is also a feature of the invention to provide carbon nanotube compositions that will improve the flammability characteristics and thermal properties of plastic materials.

It is a further feature of the present invention to provide carbon nanotube compositions that will improve the flammability characteristics of plastic materials, while at the same time, will use a low level of carbon nanotube filler such that the desirable physical properties of the host polymer are largely unaffected by the carbon nanotube filler.

It is a further feature of the present invention to provide carbon nanotube materials that will improve the flammability characteristics of plastic materials, and that will also be easily incorporated in to the host polymer, without the need for surface treatments or compatibilizing agents for dispersion of the carbon nanotube into the polymer.

It is a further feature of the present invention to provide carbon nanotube compositions that will improve the mechanical properties of the host polymer, including but not limited to stiffness, toughness and strength.

It is a further feature of the present invention to provide carbon nanotube compositions that will find use in structural sections, I-beams, the structural components of batteries, armor, and in aircraft and in space vehicles.

It is another feature of the present invention to provide carbon nanotube compositions that will find use as fillers for tires. The carbon nanotube compositions will either utilize carbon nanotubes alone, or blends with carbon black. The tires will show improved characteristics such as improved tread performance, improved wear, lower rolling resistance, lower heat build-up, and/or improved tear resistance.

It is another feature of the present invention to provide compositions using highly ordered, self-assembled, carbon nanotubes.

Additional features and advantages of the present invention will be set forth, in part in the description which follows, and in part will be apparent from the description, or may be learned by practice of the present invention. The objectives and other advantages of the present invention will be realized and obtained by means of the elements and combinations particularly pointed out in the written description and appended claims.

The present invention relates to a polymeric composition comprising at least one polymer and carbon nanotubes.

In addition, the present invention relates to methods to lower viscosity, improve conductivity, improve smoothness, and/or improve stripability of the wire and cable compound by using the polymeric compositions of the present invention.

It is to be understood that both the foregoing general description and the following detailed description are exemplary and explanatory only and are intended to provide a further explanation of the present invention, as claimed.

### BRIEF DESCRIPTION OF THE DRAWINGS

FIGS. 1a and b are electron micrographs of multi-wall carbon nanotubes in ethylene ethyl acrylate (EEA).

FIG. 2 is a graph of percolation curves for carbon black filled compositions and for carbon nanotube filled compositions.

FIG. 3 is a graph of the melt flow index versus the surface resistivity for various compositions of this invention.

### DETAILED DESCRIPTION OF THE INVENTION

The present invention relates to compositions, such as polymeric compositions, which contain carbon nanotubes. For instance, the present invention relates to polymeric compositions containing at least one polymer and carbon nanotubes. The polymeric compositions can be formed into various articles of manufacture such as, but not limited to, various types of a cable, such as an electric cable.

With respect to the nanotubes, any type of nanotube can be used in the present invention. For instance, the carbon nanotubes may be a single-walled or multi-walled (double-walled, triple-walled, or more than three walls). The nanotubes can have any physical parameters, such as any length, inner diameter, outer diameter, purity, and the like.

For instance, the outer diameter can be from 0.1 nanometer to 100 nanometers or more. The length of the nanotube can be 500 micron or less. Other lengths can be 1 micron to 70 microns or more. The number of layers forming the multi-walled nanotubes can be any amount, such as 2 to 20 layers or more.

The purity of the carbon nanotubes can be any purity, such as 20% or higher, 50% or higher, 75% or higher, 90% or higher, or 95% to 99% or higher, with respect to wt %. Again, any purity can be used in the present invention.

The carbon nanotubes can be at least 90 mol % C, or at least 99 mol % C. The nanotubes may have a metallic nanoparticle (typically Fe) at the tips of the nanotubes. The nanotubes can have a length to width aspect ratio of at least 3; or at least 10. The nanotubes can have a length of at least 1 μm, such as 5 to 200 μm; and can have a width of 3 to 100 nm. In some embodiments, as measured by SEM, at least 50% of the nanotubes have a length of 10 to 100 μm. Of the total carbon, as measured by Raman Spectroscopy, at least 50%, or at least 80%, or at least 90% of the carbon is in nanotube form as compared to amorphous or simple graphite form.

Depending on the intended use, the distribution of nanotubes can be tailored to obtain the desired characteristics, for example, surface area and thermal transport. The nanotubes can have an average separation (from central axis to central axis, as measured by SEM) of from 1 to 500 nm, more preferably 2 to 200 nm. The nanotubes can be highly aligned. In some embodiments, the nanotubes can be arranged in clumps in the composition especially where there is a high degree of nanotube alignment within each clump. The surface area of the article, as measured by BET/N₂ adsorption, can be at least 10 m²/g nanotubes, in some embodiments 100 to 200 m²/g nanotubes; and/or at least 10 m²/g nanotubes. Size and spacing of the carbon nanotubes can be controlled by control of the surfactant template composition; for example, larger diameter nanotubes can be obtained by use of larger surfactant molecules.

The carbon nanotubes can be synthesized by any method such as arc discharge method, a laser evaporation method, a thermal chemical vapor deposition (CVD) method, a catalytic synthesizing method or a plasma synthesizing method. These methods can be performed at a high temperature of several hundreds through several thousands of degrees centigrade or under a vacuum to release the high temperature condition.

In one embodiment, the nanotubes contain 10 wt % or less or less than about 5 wt % metal. In another embodiment of this invention, the single-wall carbon nanotube material contains less than about 1 wt % metal. Yet in another embodiment of this invention, the single-wall carbon nanotube material contains less than about 0.1 wt % metal. Additionally, in an embodiment of the present invention, single-wall carbon nanotube material contains less than about 50 wt % amorphous carbon. In another embodiment of the invention, single-wall carbon nanotube material of this invention contains less than about 10 wt % amorphous carbon and yet in another embodiment of this invention, single-wall carbon nanotube material contains less than about 1.0 wt % amorphous carbon.

The types of carbon nanotubes that can be used in the present invention include those described in U.S. Pat. Nos. 6,824,689; 6,752,977; 6,759,025; 6,752,977; 6,712,864; 6,517,800; 6,401,526; and 6,331,209, and in U.S. Published Patent Application Nos. 2002/0122765; 2005/0002851; 2004/0168904; 2004/0070009; and 2004/0038251. These publications describe carbon nanotubes and methods of making the same. Each of these patents and published patent applications are incorporated in their entirety by reference herein, as well as any patent or publication mentioned above or throughout the patent application.

Generally, the carbon nanotubes can be considered to be tubes or rods and can have any shape defining the tube whether it is cylindrical or multi-sided. Carbon nanotubes are available commercially, such as from Hyperion Catalysis International, Inc. of Cambridge, Mass.

Furthermore, the nanotubes can be functionalized by any treatment, such as with a diene or other known functionalizing reagents. Furthermore, the carbon nanotubes can optionally be treated so that they have one or more attached organic groups, such as attached alkyl or aromatic, or polymeric groups, or combinations thereof. Examples of representative organic groups and methods of attachment are described in U.S. Pat. Nos. 5,554,739; 5,559,169; 5,571,311; 5,575,845; 5,630,868; 5,672,198; 5,698,016; 5,837,045; 5,922,118; 5,968,243; 6,042,643; 5,900,029; 5,955,232; 5,895,522; 5,885,335; 5,851,280; 5,803,959; 5,713,988; 5,707,432; and 6,110,994; and International Patent Publication Nos. WO 97/47691; WO 99/23174; WO 99/31175; WO 99/51690; WO 99/63007; and WO 00/22051; all hereby incorporated in their entirety by reference herein. The groups and methods of attachments described in International Published Application Nos. WO 99/23174 and WO 99/63007, can also be used and are incorporated in their entirety by reference herein.

With respect to the amount of the nanotube present in the compositions of the present invention, generally, any amount can be used as long as the overall composition can be useful for its intended purpose. Strictly as an example, the amount of carbon nanotubes that can be present in the composition can range from about 0.1% by weight to about 60% or more by weight of the overall composition. More preferred amounts which can be present in the composition range from about 0.25% by weight to about 25% by weight. Other weight percents that can be used include 2 wt % to 20 wt % based on weight of the composition. Although any amount of carbon nanotube effective to achieve an intended end use may be utilized in the polymer compositions of the present invention, generally, amounts of the carbon nanotubes ranging from about 0.1 to about 300 parts by weight can be used for each 100 parts by weight of polymer. It is, however, preferred to use amounts varying from about 0.5 to about 100 parts by weight of carbon nanotubes per 100 parts by weight of polymer and especially preferred is the utilization of from about 0.5 to about 80 parts by weight of carbon nanotubes per 100 parts by weight of polymer. Preferably, the carbon nanotubes are uniformly distributed throughout the composition, though optionally, the concentration of the carbon nanotubes in various locations in the composition can vary.

An advantage of the nanotubes used in the present invention is that the nanotubes preferably impart low viscosity to the polymer compositions into which they are incorporated.

Another advantage of the nanotubes of the present invention is that the nanotubes impart low CMA (compound moisture absorption) to the polymer compositions into which they are incorporated.

A further advantage of the carbon nanotubes of the present invention is that the nanotubes may be incorporated at high or low loadings into polymer compositions.

As an option, fillers can be present along with the carbon nanotubes, such as carbon blacks or other carbon-type fillers, such as carbon fibers, and the like. Generally, any type of carbon black can be used along with the carbon nanotubes in the present invention. Preferably, the carbon black is a furnace carbon black and can be any type typically used in polymeric compositions, especially cable compounds. The carbon black can have any variety of physical properties and particle sizes.

For instance, the carbon black can have one or more of following characteristics: CDBP (dibutyl adsorption value of the crushed carbon black): 30 to 700 cc per 100 grams of carbon black.

Iodine number: 15 to 1,500 mg/g.

Primary particle size: 7 to 200 nm.

BET surface area: 12 to 1,800 m²/g

DBP: 30 to 1,000 cc per 100 grams of carbon black.

The amount of carbon black that can be used, as an option, in combination with the carbon nanotubes in the compositions in the present application can be any amount, such as from 0% by weight to about 60% or more by weight based on the overall weight of the composition. More preferred weight ranges include from about 0.1 to about 40 wt %, from about 2 wt % to about 20 wt %, and from about 3 wt % to about 15 wt %, based on the overall weight of the composition. The carbon black can be introduced into the composition, such as the polymeric composition, using conventional techniques and the carbon black is preferably uniformly distributed throughout the composition.

As with the carbon nanotubes, the carbon black can be treated with a variety of functionalizing reagents and/or can be oxidized. The carbon blacks used in the present invention can be treated such that they have an attached organic group as described above.

The carbon nanotubes and/or carbon black of the present invention can be further treated with a variety of treating agents, such as binders and/or surfactants. The treating agents described in U.S. Pat. Nos. 5,725,650; 5,200,164; 5,872,177; 5,871,706; and 5,747,559, all incorporated herein in their entirety by reference, can be used in treating the carbon blacks of the present invention. Other preferred treating agents, including surfactants and/or binders, can be used and include, but are not limited to, polyethylene glycol; alkylene oxides such as propylene oxides and/or ethylene oxides, sodium lignosulfate; acetates such as ethyl-vinyl acetates; sorbitan monooleate and ethylene oxide; ethylene/styrene/butylacrylates/methyl methacrylate binders; copolymers of butadiene and acrylonitrile; and the like. Such binders are commercially available from such manufacturers as Union Carbide, ICI, Union Pacific, Wacker/Air Products, Interpolymer Corporation, and B.F. Goodrich. These binders are preferably sold under the trade names: Vinnapas LL462, Vinnapas LL870, Vinnapas EAF650, Tween 80, Syntran 1930, Hycar 1561, Hycar 1562, Hycar 1571, Hycar 1572, PEG 1000, PEG 3350, PEG 8000, PEG 20000, PEG 35000, Synperonic PE/F38, Synperonic PE/F108, Synperonic PE/F127, and Lignosite-458.

Generally the amount of treating agent used in the present invention can be the amounts recited in the above-described patents, for instance, in an amount of from about 0.1% to about 50% by weight of the treated filler, though other amounts can be used depending upon the type of properties desired and the particular treating agent(s) being used.

Also, for purposes of the present invention, an aggregate comprising a carbon phase and a silicon containing species phase can optionally be used. A description of this aggregate as well as means of making this aggregate is described in PCT Publication No. WO 96/37547 and WO 98/47971 as well as U.S. Pat. Nos. 5,830,930; 5,869,550; 5,877,238; 5,919,841; 5,948,835; and 5,977,213. All of these patents and publications are hereby incorporated in their entireties herein by reference.

An aggregate comprising a carbon phase and metal-containing species phase can optionally be used where the metal-containing species phase can be a variety of different metals such as magnesium, calcium, titanium, vanadium, cobalt, nickel, zirconium, tin, antimony, chromium, neodymium, lead, tellurium, barium, cesium, iron, molybdenum, aluminum, and zinc, and mixtures thereof. The aggregate comprising the carbon phase and a metal-containing species phase is described in U.S. Pat. No. 6,017,980, also hereby incorporated in its entirety herein by reference.

Also, for purposes of the present invention, a silica coated carbon black can optionally be used, such as that described in U.S. Pat. No. 5,916,934 and PCT Publication No. WO 96/37547, published Nov. 28, 1996, also hereby incorporated in their entirety herein by reference.

With respect to the polymer, as stated, at least one polymer is present in the polymeric compositions of the present invention. Blends can be used, such as two or more polymers. The polymer can be a homopolymer, copolymer, or be formed by polymerization of any number of monomers. The polymer can be a thermoplastic or thermoset.

Among the polymers suitable for use with the present invention are natural rubber, synthetic rubber and their derivatives such as chlorinated rubber; copolymers of from about 10 to about 70 percent by weight of styrene and from about 90 to about 30 percent by weight of butadiene such as copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl-2-vinylpyridine, 5-ethyl-2-vinylpyridine, 2-methyl-5-vinylpyridine, alkyl-substituted acrylates, vinyl ketone, methyl isopropenyl ketone, methyl vinyl ether, alphamethylene carboxylic acids and the esters and amides thereof such as acrylic acid and dialkylacrylic acid amide; also suitable for use herein are copolymers of ethylene and other high alpha olefins such as propylene, butene-1 and pentene-1; particularly preferred are the ethylene-propylene copolymers wherein the ethylene content ranges from 20 to 90 percent by weight and also the ethylene-propylene polymers which additionally contain a third monomer such as dicyclopentadiene, 1,4-hexadiene and methylene norbornene.

Additionally preferred polymeric compositions are polyolefins such as polypropylene and polyethylene. Suitable polymers also include:

a) propylene homopolymers, ethylene homopolymers, and ethylene copolymers and graft polymers where the co-monomers are selected from butene, hexene, propene, octene, vinyl acetate, acrylic acid, methacrylic acid, C₁₋₈ alkyl esters of acrylic acid, C₁₋₈ alkyl esters of methacrylic acid, maleic anhydride, half ester of maleic anhydride, and carbon monoxide;

b) elastomers selected from natural rubber, polybutadiene, polyisoprene, random or block styrene butadiene rubber (SBR), polychloroprene, acrylonitrile butadiene, ethylene propylene co and terpolymers, ethylene propylene diene monomer (EPDM);

c) homopolymers and copolymers of styrene, including styrene-butadiene styrene linear and radial polymer, acrylonitrile butadiene styrene (ABS) and styrene acrylonitrile (SAN);

d) thermoplastics, including polyethylene terephthalate (PET), polybutylene terephthalate (PBT), polycarbonates, polyamides, polyvinyl chlorides (PVC), acetals; and

e) thermosets, including polyurethane, epoxies and polyesters.

Additionally preferred polymeric compositions are polyolefins such as polypropylene and polyethylene, polystyrene, polycarbonate, nylon, or copolymers thereof. Examples include, but are not limited to, LLDPE, HDPE, MDPE, and the like.

In one embodiment, the composition is an ethylene containing polymer or elastomer, such as, but not limited to, polyethylene or an ethylene copolymers, ethylene-propylene rubber, ethylene-vinyl acetate (EVA), and/or ethylene ethyl acrylate (EEA).

The polymer compositions may include other conventional additives such as curing agents, processing additives, hydrocarbon oils, accelerators, coagents, antioxidants and the like.

The compositions of the present invention may also include suitable additives for their known purposes and in known and effective amounts. For example, the compositions of the present invention may also include such additives as cross-linking agents, vulcanizing agents, stabilizers, pigments, dyes, colorants, metal deactivators, oil extenders, lubricants, inorganic fillers, and the like. These components are well-known to those of skill in the art, and any compositions that would be recognized as suitable to one of skill in the art can be used.

The polymer compositions of the present invention may be produced by any manner known in the art for combining polymers and particulate components.

Articles of manufacture containing the composition of the present invention can be made. A preferred article of manufacture is an extruded article, such as a cable (or part thereof), profile, tube, tape, or film. These articles can be used for static dissipation, in automotive applications, and generally as electrical conductors.

The polymeric compositions of the present invention can form any part of an article. The polymer compositions of the present invention containing the nanotubes of the present invention have particular useful applications with regard to UV application such as pipe, film, membranes, jacketing, components thereof, and fittings thereof, and the like. The pipes and the like can be any suitable size or thickness. Thus, articles that can be formed at least in part from the polymer compositions of the present invention include, but are not limited to, pipe, cable jacketing, membranes, molding, and the like. Particularly preferred examples of articles that can be formed, at least in part from the polymer compositions of the present invention, are pressure pipes, for such uses as potable water, gas, and other liquids and gases, and the like. The designs, components, and uses described, for instance, in U.S. Pat. Nos. 6,024,135 and 6,273,142 can be used herein and are incorporated in their entirety by reference herein.

Another preferred article is a bonded or strippable conductive wire or cable coating compound. Also preferred as an article of manufacture of the present invention is a medium or high voltage cable comprising:

a) A metal conductor core;

b) A semi-conductive shield or conductor shield;

c) An insulation layer; and

d) An outer semi-conductive layer or insulation shield.

e) Neutral conductors; and

f) A cable jacket.

The compositions of the present invention, for instance, can be used in b), d), and/or f) above. Further, the composition can be strippable or bonded.

The compositions of the present invention can be a shielding composition and/or outer semi-conductive layer or insulation shield. These compositions are known as strand shielding compositions and insulation compositions.

For instance, the carbon nanotubes can be incorporated into shielding compositions in various amounts such as from about 0.01% to about 50% by weight of the shielding composition, and more preferably from about 0.25% to about 35% based on the weight of the shielding composition, and most preferably from about 1% to about 25% by weight of the shielding composition.

Preferably, the shielding compositions of the present invention contain an ethylene containing polymer or polyethylene such as an ethylene-vinyl acetate copolymer and a crosslinking agent such as an organic peroxide crosslinking agent. The shielding compositions of the present invention can further contain other polymers such as an acrylonitrile butadiene polymer (e.g., an acrylonitrile butadiene copolymer). If the carbon nanotube or carbon black has a treating agent on it, such as in the form of an acrylonitrile butadiene copolymer, then the amount of acrylonitrile butadiene polymer or other polymer(s) that may be present can be reduced or eliminated in the shielding composition.

Preferably, the ethylene containing polymer is an ethylene-vinyl acetate copolymer or ethylene ethyl acrylate copolymer which is preferably present in an amount of from 20 to about 50% by weight based on the weight of the shielding composition and more preferably, from about 25 to about 45 weight %.

Typically, the semi-conductive compositions may be made by combining one or more polymers with an amount of conductive filler sufficient to render the composition semi-conductive. Similarly, insulating materials may be formed by incorporating minor amounts of filler, for example, as a colorant or reinforcing agent, into a polymer composition. Insulating material may be formed by combining a polymer and an amount of conductive filler much less than that sufficient to impart semi-conductive properties to the material. For example, the polymeric compositions of the present invention may be made by combining a polymer, such as a polyolefin, with an amount of filler sufficient to render the composition semi-conductive.

The polymer compositions of the present invention may be incorporated into any product where the properties of the polymer compositions are suitable. For example, the polymer compositions are particularly useful for making insulated electrical conductors, such as electrical wires and power cables. Depending on the conductivity of the polymer compositions, the polymer composition may be used, for example, as a semi-conductive material or as an insulating material in such wires and cables.

More preferably, a semi-conductive shield of the polymer composition may be formed directly over the inner electrical conductor as a conductor shield, or over an insulating material as a bonded or strippable insulation shield, or as an outer jacketing material. The carbon nanotubes in the selected polymer compositions may also be used in strand filling applications in either conductive or nonconductive formulations.

Typically, the components of an electric cable are a conductive core (such as a multiplicity of conductive wires) surrounded by several protective layers. Additionally, the conductive core may contain a strand filler with conductive wires, such as a water blocking compound. The protective layers include a jacket layer, an insulating layer, and a semi-conductive shield. In a cable, typically conductive wires will be surrounded by a semi-conductor shield which in turn is surrounded by an insulation layer which in turn is surrounded by a semi-conductor shield and then a metallic tape shield, and finally, the jacket layer.

Polymeric materials offer several advantages over metals as a material for automotive applications, and consequently are becoming a material of choice for many automotive components. For example, polymeric materials are preferably used for almost all of the components of an automotive fuel system, such as the fuel inlet, filler neck, fuel tanks, fuel lines, fuel filter, and pump housings. Many of these polymeric compounds, however, are non-conducting materials. Automobiles contain more and more electronically operated devices, such as anti-lock brake systems (ABS), electronic fuel injection, satellite based global positioning systems (GPS), and onboard central computers. In order to ensure the safe operation of all of these devices, polymeric materials which provide electrostatic discharge protection and electrostatic dissipative (ESD) properties to automobile parts such as the internal trim, dashboards, panel, seat fibers, switches, and housings are needed. In addition, electrostatic painting (ESP) is often used to prepare the coated articles for automotive applications. In ESP, a paint or coat is ionized or charged and sprayed on the grounded or conductive article. The electrostatic attraction between the paint or coating and the grounded article results in a more efficient painting process with less wasted paint material and more consistent paint coverage for simple and complex shaped articles. However, polymeric materials that are used in the automotive industry for superior corrosive properties and reduced weight property are typically insulative and non-conducting.

In electromotive coating processes, an electrical potential is used between the substrate being coated and the coating material in order to provide an efficient painting process. In more detail, a paint or coating is charged or ionized and sprayed on a grounded article. The electrostatic attraction between the paint or coating and the grounded, conductive article results in a more efficient painting process with less wasted paint material. Furthermore, an additional benefit of the process is a thicker and more consistent paint coverage. When articles fabricated from metals are painted, the metal which is inherently conductive, is easily grounded and efficiently painted. However, with the use of polymeric materials in the manufacture of many articles, especially automotive applications, the polymers are insufficiently conductive or not conductive at all and therefore do not obtain satisfactory paint thickness and coverage when the article is electrostatically painted. In an effort to overcome this difficulty, compositions containing conductive fibers have been used as well as the use of ion-conductive metal salts. In addition, U.S. Pat. No. 5,844,037, which is incorporated in its entirety by reference herein, provides a mixture of polymers with an electrically-conductive carbon. As shown in that patent, preferably low amounts of electrically-conductive carbon such as from 0.1 to 12% by weight, is used in combination with an amorphous or semi-crystalline thermoplastic polymer and a second semi-crystalline thermoplastic polymer having a different degree of crystallinity.

U.S. Pat. Nos. 5,902,517, 6,156,837, 6,086,792, 5,877,250, 5,844,037, and 5,484,838, as well as U.S. patent application Ser. No. 09/728,706, each incorporated in their entirety by reference, relate to carbon blacks and semiconductive or conductive polymer compositions and articles. However, there remains a need to provide conductive polymer compositions having high compound conductivity while at the same time having levels of toughness, stiffness, smoothness, tensile properties, etc. that are acceptable for use in automotive applications.

The present invention relates to a conductive polymer containing at least one polymer and at least one type of carbon nanotubes of the present invention optionally with one or more types of carbon black.

With respect to the polymer present in the conductive polymer compositions of the present invention, the polymer can be any polymeric compound. Preferably, the polymer is one that is useful in automotive applications, such as a polyolefin, a vinylhalide polymer, a vinylidene halide polymer, a perfluorinated polymer, a styrene polymer, an amide polymer, a polycarbonate, a polyester, a polyphenyleneoxide, a polyphenylene ether, a polyketone, a polyacetal, a vinyl alcohol polymer, or a polyurethane. Blends of polymers containing one or more of these polymeric materials, where the described polymers are present either as the major component or the minor component, may also be used. The specific type of polymer can depend on the desired application. These are described in more detail below. The polymer compositions of the present invention may also include suitable additives for their known purposes and amounts. For example, the compositions of the present invention may also include such additives as crosslinking agents, vulcanizing agents, stabilizers, pigments, dyes, colorants, metal deactivators, oil extenders, lubricants, inorganic fillers, and the like. The polymer compositions of the present invention can be prepared using conventional techniques such as mixing the various components together using commercially available mixers. The composition may be prepared by batch or continuous mixing processes such as those well known in the art. For example, equipment such as discontinuous internal mixers, continuous internal mixers, reciprocating single screw extruder, twin and single screw extruder, etc. may be used to mix the ingredients of the formulations. The carbon nanotubes may be introduced directly into the polymer blend, or the carbon nanotubes may be introduced into one of the polymers before that polymer is blended with another polymer. The components of the polymer compositions of the present invention may be mixed and formed into pellets for future use in manufacturing such materials as articles for automotive applications.

The conductive polymer compositions of the present invention are particularly useful for preparing automotive articles. In particular, the conductive compositions can be used for components of an automotive fuel system such as, for example, a fuel inlet, filler neck, fuel tank, fuel line, fuel filter, and pump housing. In addition, the conductive polymer compositions of the present invention can be used in automotive applications in which electrostatic discharge protection and electrostatic dissipative properties are important. Examples include internal trim, dashboards, panels, bumper fascia, mirrors, seat fibers, switches, housings, and the like. The present invention can be used in safety systems, such as those used in automotives. For instance, a finger trap safety system can include the conductive compositions of the present invention as the conductive zones, where two conductive components or zones are generally used and generally separated by an insulating compound. The articles, such as automotive articles, of the present invention can be prepared from the polymer compositions of the present invention using any technique known to one skilled in the art. Examples include, but are not limited to, extrusion, multilayer coextrusion, blow molding, multilayer blow molding, injection molding, rotomolding, thermoforming, and the like. In order to prepare these articles, such as automotive articles, it may be preferable to use specific polymers or blends in order to attain the desired performance properties. For example, preferred polymers for the fuel system components include thermoplastic polyolefins (TPO), polyethylene (PE), polypropylene (PP), copolymers of propylene, ethylene propylene rubber (EPR), ethylene propylene diene terpolymers (such as EPDM), acrylonitrile butadiene styrene (ABS), acrylonitrile EPDM styrene (AES), polyvinylchloride (PVC), polystyrene (PS), polyamides (PA, such as PA6, PA66, PA 11, PA12, and PA46), polycarbonate (PC), polybutylene terephthalate (PBT), polyethylene terephthalate (PET), polyphenylene oxide (PPO), and polyphenylene ether (PPE). Preferred polymer blends include, but are not limited to, PC/ABS, PC/PBT, PP/EPDM, PP/EPR, PP/PE, PA/PPO, and PPO/PP. The polymer compositions of the present invention can be optimized to attain the desired overall properties, such as conductivity, toughness, stiffness, smoothness, and tensile properties. For automotive parts for electrostatic dissipative protection, preferred polymers include thermoplastic polyolefins (TPO), polyethylene (PE, such as LLDPE, LDPE, HDPE, UHMWPE, VLDPE, and mLLDPE), polypropylene, copolymers of polypropylene, ethylene propylene rubber (EPR), ethylene propylene diene terpolymers (such as EPDM), acrylonitrile butadiene styrene (ABS), acrylonitrile EPDM styrene (AES), polyoxymethylene (POM), polyamides (PA, such as PA6, PA66, PA11, PA12, and PA46), polyvinylchloride (PVC), tetraethylene hexapropylene vinylidenefluoride polymers (THV), perfluoroalkoxy polymers (PFA), polyhexafluoropropylene (HFP), polyketones (PK), ethylene vinyl alcohol (EVOH), copolyesters, polyurethanes (PU), polystyrene (PS), polycarbonate (PC), polybutylene terephthalate (PBT), polyethylene terephthalate (PET), polypheneylene oxide (PPO), and polyphenylene ether (PPE). Preferred blends include PC/ABS, PC/PBT, PP/EPDM, PP/EPR, PP/PE, PA/PPO, and PPO/PE. The polymer compositions used to prepare these automotive articles can also be optimized to attain the desired overall performance.

The present invention further relates to a method of electrostatic painting of an article, as well as to the resulting painted particle. This method involves the step of electrostatically applying paint to the surface of an article, such as an automotive article, which has been formed from the conductive polymer compositions of the present invention. As with the fuel system and electrostatic dissipative protection applications described above, some polymers are preferred for use in preparing the articles that are electrostatically painted. Examples of these polymers include thermoplastic polyolefins (TPO), polyethylene (PE), polypropylene (PP), copolymers of propylene, ethylene propylene rubber (EPR), ethylene propylene diene terpolymer (such as EPDM), acrylonitrile butadiene styrene (ABS), acrylonitrile EPDM styrene (AES), polyvinylchloride (PVC), polystyrene (PS), polyamides (PA, such as PA6, PA66, PA11, PA12, and PA46), polycarbonate (PC), polybutylene terephthalate (PBT), polyethylene terephthalate (PET), polyphenylene oxide (PPO), and polyphenylene ether (PPE). Preferred polymer blends include, but are not limited to, PC/ABS, PC/PBT, PP/EPDM, PP/EPR, PP/PE, PA/PPO, and PPO/PE. The conductive polymer compositions can be optimized in order to attain the desired overall performance, including conductivity, surface smoothness, paint adhesion, toughness, stiffness, and tensile properties.

The conductive polymer compositions of the present invention preferably provide a balance of beneficial properties which are useful in applications such as automotive applications. In particular, the polymer composition preferably has a volume resistivity that is greater than 100 ohm-cm and, more preferably, greater than 1000 ohm-cm, when measured at room temperature. Further, these compositions have a volume resistivity that is lower than 10¹² ohm-cm, and, more preferably, lower than 10⁹ ohm-cm. This makes these compositions particularly useful for the automotive applications described above. Surface resistivity would also be excellent in the present invention, such as lower than 10¹² ohm-cm and preferably less than 10¹⁰ or 10⁸ ohm-cm.

The compositions of the present invention preferably provide a balance of beneficial properties, such as good viscosity, high smoothness, acceptable conductivity, and/or good stripability.

As stated, the carbon nanotubes have the ability to provide or promote a lower viscosity which improves the ability to disperse the carbon nanotube throughout the polymeric composition. The carbon nanotubes also preferably improve the conductivity range of the shielding composition such that volume resistivity is about 10¹² OMEGA cm or less, per ISO 3915 at 15% by weight loading in ethylene ethyl acrylate, and more preferably is about 10⁵ OMEGA cm or less, and even more preferably about 1,000 OMEGA cm or less.

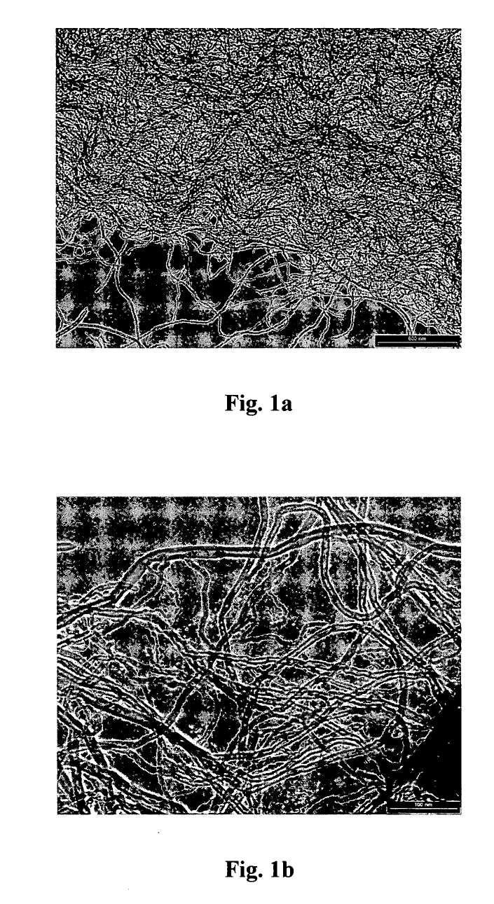

Electron micrographs of multi-wall carbon nanotubes in ethylene ethyl acrylate (EEA) are shown in FIG. 1. The micrographs show that the carbon nanotubes have nest type structures in the polymer.

Table 5 shows a summary of physical and electrical properties that have been measured for various compositions of the present invention. The first column sets forth results from a furnace test conducted in order to determine the filler content of the composition. This involves burning the material in a furnace at about 950° C. under an inert atmosphere to remove all polymer and to leave the conductive filler only. The second column sets forth the measured melt flow index of various compositions.

Column 3 of Table 5 provides the surface conductivity of various compositions of the invention. The conductivity was measured by first preparing compression moulded plaques. The compression moulded plaques typically had a size of about 16×16 cm and were about 1 mm thick. They were prepared by using the following compression moulding program. Two minutes under 90 kN pressure at 180° C.; then 3 minutes under 180 kN pressure at 180° C.; then three minutes under 270 kN pressure at 180° C.; then cooling for 2 minutes under a pressure of 90 kN between two water cooled plates. The surface reactivity of each plaque was then measured.

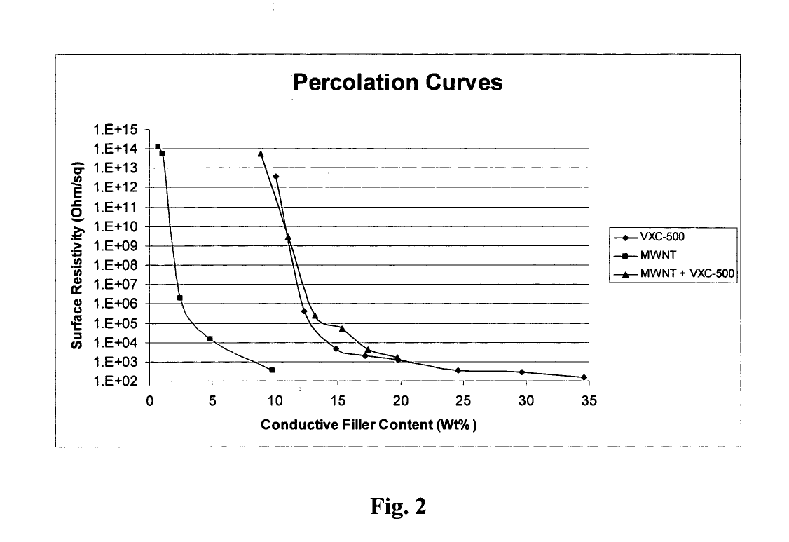

A percolation curve for carbon black filled compositions and for carbon nanotube filled compositions is shown in FIG. 2. This data indicates that the percolation threshold of the carbon nanotube filled compounds is around six times lower than for the carbon black filled compounds. This is the case even though relatively impure (80%) multi-walled carbon nanotube was used in these experiments.

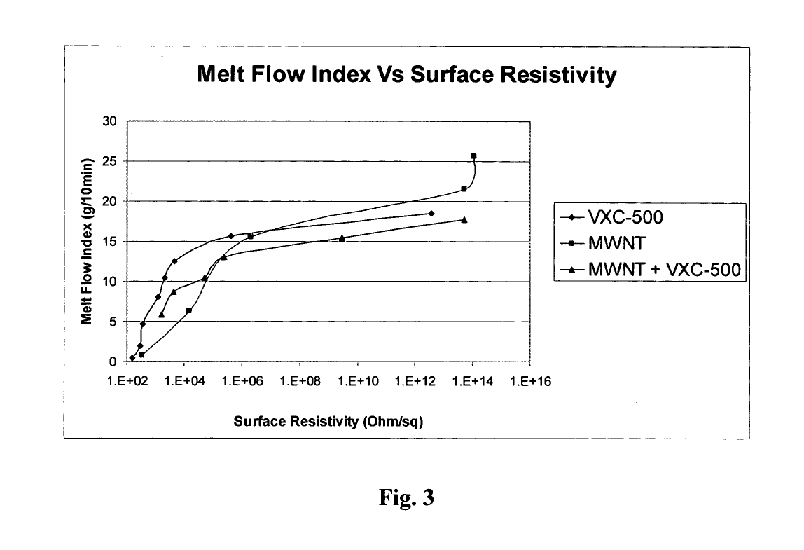

FIG. 3 shows the melt flow index versus the surface resistivity for various compositions of this invention.

In certain embodiments of the present invention, the use of the carbon nanotubes can reduce the overall amount of fillers used in compositions, such as polymeric compositions. In other words, the use of carbon nanotubes alone or in combination with carbon black can reduce the overall percent by weight of the filler, thus providing numerous benefits including lower density, lower viscosity, lower compound moisture absorption, dispersion quality, and/or superior smoothness.

In at least one embodiment, the carbon nanotubes in combination with the carbon black provide a synergistic result wherein the combination of carbon nanotubes with carbon black achieve the same, about the same, or better properties with respect to lower density, lower viscosity, lower compound moisture absorption, dispersion quality, and/or superior smoothness, compared to the use of the same total weight filler percent amount, except all carbon black. Thus, the use carbon nanotubes, especially in association with carbon black, leads to an overall reduction of the amount of filler needed to achieve at least one of the same properties in a composition such as a polymeric composition, for instance, used as a component of an electric cable.

The incorporation of the carbon nanotubes and carbon black into a composition, such as a polymeric composition, can occur in any way. For instance, the carbon black with carbon nanotubes can first be premixed together in a dry form or a liquid form, such as in a carrier solution or slurry. Alternatively, the carbon nanotubes and/or carbon blacks can be first introduced in the composition. Essentially, any order of introduction of the various ingredients that comprise the composition can be achieved. Furthermore, the polymers present in the composition can even be formed in situ in the presence of the carbon nanotubes and optionally carbon black.

The polymeric compositions of the present invention can be made using conventional techniques such as mixing the various components together using commercially available mixers. The compositions can then be formed into the desired thickness and length and width using conventional techniques known to those skilled in the art, such as described in EP 0420271; U.S. Pat. Nos. 4,412,938; 4,288,023; and 4,150,193 all incorporated herein in their entirety by reference.

In more detail, the polymer compositions of the present invention may be manufactured using conventional machinery and methods to produce the desired final polymer product. The composition may be prepared by batch or continuous mixing processes such as those well known in the art. For example, equipment such as Banbury mixers, Buss co-kneaders, and twin screw extruders may be used to mix the ingredients of the formulations. For instance, the components of the polymer compositions of the present invention may be mixed and formed into pellets for future use in manufacturing such materials as insulated electrical conductors.

The following testing procedures were used in the determination and evaluation of the analytical properties of the carbon blacks of the present invention, and the of the polymer compositions incorporating the carbon blacks of the present invention.

The CTAB (cetyl trimethyl ammonium bromide adsorption area) of the carbon blacks was determined according to ASTM Test Procedure D3750-85.

The I₂ No. was determined according to ASTM Test Procedure D 1510. The Tint value (“Tint”) of the carbon blacks was determined according to the procedure set forth in ASTM D3250.

The DBP (dibutyl phthalate absorption value) of the carbon black pellets was determined according to ASTM Test Procedure D2414.

The CDBP (crushed dibutyl phthalate absorption value) of the carbon black pellets was determined according to the procedure set forth in ASTM D3493-86.

The toluene extract level of the carbon blacks was determined utilizing a Milton Roy Spectronic 20 Spectrophotometer, manufactured by Milton Roy, Rochester, N.Y. according to ASTM Test Procedure D1618.

The particle size of the carbon blacks was determined according to the procedure set forth in ASTM D3849-89.

The present invention will be further clarified by the following examples, which are intended to be exemplary of the present invention.

### Example 1

The compounding equipment was a high shear internal mixer Haake Rheocord 90 equipped with a mixing chamber with two counter rotating Brabender shape blades. For each compound, the following procedure was used. First the polymer in pellets was introduced into the mixing chamber. Once the material melted under the action of the operating temperature and the two counter rotating blades, the carbon black (Vulcan XC-500® carbon black) or Thin Crude Multi-Wall Carbon Nanotube (MWNT) was introduced into the mixing chamber.

At the completion of the mixing cycle (1 min @40 RPM/40 to 200 RPM in 3 min/2 min @200 RPM), the compound was recovered from the mixer and flattened by pressing out between two sheets of Mylar sheets on a hydraulic press. The material was then cut into small pieces in order to perform a second mixing cycle to ensure a good dispersion of the filler and homogeneous compound.

Several compounds were made at different loadings (wt %):

for carbon black: 35-30-25-20-17.5-15-12.5-10%

for MWNT: 10-5-2.5-1-0.75%

for carbon black/MWNT blend ratio 10/1:19.8-17.6-15.4-13.2-11.0-8.8% in EEA LE5861 from Borealis with a nominal MFI of 6 g/10 min @190° C./2.16 kg.

Filler loadings were evaluated by burning out of a defined weight of the compound in a furnace @950° C. under inert atmosphere. The remaining material was the carbon black or the MWNT, which was then weighed in order to determine its weight percentage.

The physical and electrical properties that were evaluated are:
Melt Flow Index @190° C.
Surface Resistivity on 1 mm thick plaques by following Cabot Test Method E042A “Surface Resistivity on Compression Moulded Plaques,” that is based on IEC 167, “Surface Resistivity on Compression Moulded Plaques.”

### Experimental Results

### Compounding

As explained above the compounds were made in two steps. The first mixing cycle was used to incorporate the conductive filler and to start dispersing it, while second one was used to ensure a good dispersion and homogeneity.

One mixing cycle lasted 6 minutes and consists of three steps:

1) 1 min @40 RPM

2) increase of speed from 40 to 200 RPM during 3 min.

3) 2 min @200 RPM
“WEIGHT CB EEA” for the compounds of Carbon Black in EEA.
“WEIGHT CNT EEA” for the compounds of MWNT in EEA.
“WEIGHT CNT-CB EEA” for the compounds with blends of CB-MWNT ratio 10-1 in EEA.

Each compound was made by addition of the conductive filler into the molten polymer which was added first in the mixing chamber.

For the compounds containing blends of carbon black with MWNT, the compounds at 35 wt % CB and 10 wt % MWNT were used respectively which have been diluted in order to get a good accuracy in the dosage.

The results of the compounding were as follows:

TABLE 1

| | Set T ° | | Melt T ° | Total Torque |
|---|---|---|---|---|
| Compound (wt %) | (° C.) | Step | (° C.) | (NmM) |
| EEA + 35% CB | 130 | 1 | 181 | 92.81 |
| | | 2 | 178 | 85.45 |
| EEA + 30% CB | 130 | 1 | 174 | 75.97 |
| | | 2 | 171 | 70.00 |
| EEA + 25% CB | 130 | 1 | 167 | 62.40 |
| | | 2 | 165 | 59.45 |
| EEA + 20% CB | 130 | 1 | 162 | 53.59 |
| | | 2 | 161 | 52.49 |
| EEA + 17.5% CB | 130 | 1 | 161 | 49.66 |
| | | 2 | 160 | 49.10 |
| EEA + 15% CB | 130 | 1 | 159 | 46.34 |
| | | 2 | 157 | 46.19 |
| EEA + 12.5% CB | 130 | 1 | 157 | 43.46 |
| | | 2 | 155 | 42.21 |
| EEA + 10% CB | 130 | 1 | 155 | 40.85 |
| | | 2 | 153 | 37.41 |
| EEA + 10% MWNT | 130 | 1 | 172 | 69.63 |
| | | 2 | 167 | 62.32 |
| EEA + 5% MWNT | 130 | 1 | 165 | 47.32 |
| | | 2 | 159 | 48.25 |
| EEA + 2.5% MWNT | 130 | 1 | 162 | 37.25 |
| | | 2 | 155 | 39.96 |
| EEA + 1% MWNT | 130 | 1 | 151 | 34.40 |
| | | 2 | 151 | 34.24 |
| EEA + 0.75% MWNT | 130 | 1 | 149 | 35.34 |
| | | 2 | 149 | 32.54 |
| EEA + 1.8% MWNT + | 130 | 1 | 161 | 52.74 |
| 18% CB | | 2 | 161 | 52.50 |
| EEA + 1.6% MWNT + | 130 | 1 | 159 | 47.68 |
| 16% CB | | 2 | 159 | 49.37 |
| EEA + 1.4% MWNT + | 130 | 1 | 156 | 45.10 |
| 14% CB | | 2 | 156 | 43.38 |
| EEA + 1.2% MWNT + | 130 | 1 | 156 | 39.71 |
| 12% CB | | 2 | 156 | 38.35 |
| EEA + 1.0% MWNT + | 130 | 1 | 155 | 35.92 |
| 10% CB | | 2 | 153 | 32.64 |
| EEA + 0.8% MWNT + | 130 | 1 | 155 | 37.48 |
| 8% CB | | 2 | 153 | 38.12 |

Remarks:
1) NmM unit of Total Torque means Kilogram · Meter · Minutes and is used as an indication of the compound melt viscosity.
2) Melt T ° corresponds to the final temperature of the compound at the end of the corresponding mixing cycle.

### Furnace Test

Furnace test was performed in order to evaluate the conductive filler content in the compound. It consists in the burning of the material in a furnace @950° C. under an inert atmosphere to remove all the polymer and to leave the conductive filler only. This test has been performed according to Cabot Test Method E010.

On compounds containing MWNT, an Ash Residue was also preformed to evaluate the level of catalytic support in the MWNT.

TABLE 2

| Compound (wt %) | Nitrogen Residue (wt %) | Ash Residue (wt %) |
|---|---|---|
| EEA + 35% CB | 34.55 | / |
| EEA + 30% CB | 29.64 | / |
| EEA + 25% CB | 24.58 | / |
| EEA + 20% CB | 19.76 | / |
| EEA + 17.5% CB | 17.21 | / |
| EEA + 15% CB | 14.87 | / |
| EEA + 12.5% CB | 12.32 | / |
| EEA + 10% CB | 10.10 | / |
| EEA + 10% MWNT | 9.76 | 2.14 |
| EEA + 5% MWNT | 4.84 | 1.04 |
| EEA + 2.5% MWNT | 2.44 | 0.46 |
| EEA + 1% MWNT | 1.04 | 0.20 |
| EEA + 0.75% MWNT | 0.73 | 0.16 |
| EEA + 1.8% MWNT + | 19.71 | 0.31 |
| 18% CB | | |
| EEA + 1.6% MWNT + | 17.41 | 0.30 |
| 16% CB | | |
| EEA + 1.4% MWNT + | 15.34 | 0.28 |
| 14% CB | | |
| EEA + 1.2% MWNT + | 13.19 | 0.18 |
| 12% CB | | |
| EEA + 1.0% MWNT + | 11.05 | 0.20 |
| 10% CB | | |
| EEA + 0.8% MWNT + | 8.87 | 0.16 |
| 8% CB | | |

### Melt Flow Index

Melt Flow Index (MFI) was performed according to Cabot Test Method E005.

TABLE 3

| | T ° | Weight Load | MFI |
|---|---|---|---|
| Compound (wt %) | (° C.) | (Kg) | (g/10 min) |
| EEA | 190 | 5.0 | 27.0 |
| EEA + 35% CB | 190 | 5.0 | 0.4 |
| EEA + 30% CB | 190 | 5.0 | 2.0 |
| EEA + 25% CB | 190 | 5.0 | 4.7 |
| EEA + 20% CB | 190 | 5.0 | 8.0 |
| EEA + 17.5% CB | 190 | 5.0 | 10.4 |
| EEA + 15% CB | 190 | 5.0 | 12.5 |
| EEA + 12.5% CB | 190 | 5.0 | 15.7 |
| EEA + 10% CB | 190 | 5.0 | 18.5 |
| EEA + 10% MWNT | 190 | 5.0 | 0.7 |
| EEA + 5% MWNT | 190 | 5.0 | 6.3 |
| EEA + 2.5% MWNT | 190 | 5.0 | 15.5 |
| EEA + 1% MWNT | 190 | 5.0 | 21.5 |
| EEA + 0.75% MWNT | 190 | 5.0 | 25.7 |
| EEA + 1.8% MWNT + | 190 | 5.0 | 5.9 |
| 18% CB | | | |
| EEA + 1.6% MWNT + | 190 | 5.0 | 8.7 |
| 16% CB | | | |
| EEA + 1.4% MWNT + | 190 | 5.0 | 10.4 |
| 14% CB | | | |
| EEA + 1.2% MWNT + | 190 | 5.0 | 13.0 |
| 12% CB | | | |
| EEA + 1.0% MWNT + | 190 | 5.0 | 15.4 |
| 10% CB | | | |
| EEA + 0.8% MWNT + | 190 | 5.0 | 17.7 |
| 8% CB | | | |

### Conductivity

In order to measure the conductivity, compression moulded plaques were prepared with the compounds. The compression moulded plaques had a size of 16×16 cm and were 1 mm thick. They were prepared by using the following compression moulding program:

1) 2 min under 901N pressure @180° C.

2) 3 min under 1801N pressure @180° C.

3) 3 min under 270 kN pressure @180° C.

4) cooling down during 2 min under a pressure of 90 kN between two water-cooled plates.

Each plaque was then used to measure the surface resistivity by following the Cabot Test Method E042A for Surface Resistivity. The electrical conductivity of the resultant composite was measured by cutting 101.6 mm×6.35 mm×1.8 mm strips from the molded plaque, and colloidal silver paint was used to fabricate electrodes 50 mm apart along the strips in order to remove the contact resistance. A Fluke 75 Series II digital multimeter or Keithley multimeter and a 2 point technique was used to measure the electrical resistance of the strips.

| Compound (wt %) | Surface Resistivity (Ohm/sq) | |
|---|---|---|
| EEA + 35% CB | Fluke | 1.5E+02 |
| EEA + 30% CB | Fluke | 2.8E+02 |
| EEA + 25% CB | Fluke | 3.6E+02 |
| EEA + 20% CB | Fluke | 1.2E+03 |
| EEA + 17.5% CB | Fluke | 2.1E+03 |
| EEA + 15% CB | Fluke | 4.7E+03 |
| EEA + 12.5% CB | Fluke | 4.3E+05 |
| EEA + 10% CB | Keithley (100 V) | 3.8E+12 |
| EEA + 10% MWNT | Fluke | 3.4E+02 |
| EEA + 5% MWNT | Fluke | 1.5E+04 |
| EEA + 2.5% MWNT | Fluke | 2.0E+06 |
| EEA + 1% MWNT | Keithley (100 V) | 5.2E+13 |
| EEA + 0.75% MWNT | Keithley (100 V) | 1.2E+14 |
| EEA + 1.8% MWNT + | Fluke | 1.6E+03 |
| 18% CB | | |
| EEA + 1.6% MWNT + | Fluke | 4.1E+03 |
| 16% CB | | |
| EEA + 1.4% MWNT + | Fluke | 4.9E+04 |
| 14% CB | | |
| EEA + 1.2% MWNT + | Fluke | 2.4E+05 |
| 12% CB | | |
| EEA + 1.0% MWNT + | Keithley (100 V) | 2.8E+09 |
| 10% CB | | |
| EEA + 0.8% MWNT + | Keithley (100 V) | 5.2E+13 |
| 8% CB | | |

### Discussion

Table 5 summarizes the data:

TABLE 5

| | Nitrogen | | Surface |
|---|---|---|---|
| | Residue | MFI @190° C./ | Resistivity |
| Compound (wt %) | (wt %) | 5.0 kg (g/10 min) | (Ohm/sq) |
| EEA | 0 | 27.0 | N.A. |
| EEA + 35% CB | 34.55 | 0.4 | 1.5E+02 |
| EEA + 30% CB | 29.64 | 2.0 | 2.8E+02 |
| EEA + 25% CB | 24.58 | 4.7 | 3.6E+02 |
| EEA + 20% CB | 19.76 | 8.0 | 1.2E+03 |
| EEA + 17.5% CB | 17.21 | 10.4 | 2.1E+03 |
| EEA + 15% CB | 14.87 | 12.5 | 4.7E+03 |
| EEA + 12.5% CB | 12.32 | 15.7 | 4.3E+05 |
| EEA + 10% CB | 10.10 | 18.5 | 3.8E+12 |
| EEA + 10% MWNT | 9.76 | 0.7 | 3.4E+02 |
| EEA + 5% MWNT | 4.84 | 6.3 | 1.5E+04 |
| EEA + 2.5% MWNT | 2.44 | 15.5 | 2.0E+06 |
| EEA + 1% MWNT | 1.04 | 21.5 | 5.2E+13 |
| EEA + 0.75% MWNT | 0.73 | 25.7 | 1.2E+14 |
| EEA + 1.8% MWNT + | 19.71 | 5.9 | 1.6E+03 |
| 18% CB | | | |
| EEA + 1.6% MWNT + | 17.41 | 8.7 | 4.1E+03 |
| 16% CB | | | |
| EEA + 1.4% MWNT + | 15.34 | 10.4 | 4.9E+04 |
| 14% CB | | | |
| EEA + 1.2% MWNT + | 13.19 | 13.0 | 2.4E+05 |
| 12% CB | | | |
| EEA + 1.0% MWNT + | 11.05 | 15.4 | 2.8E+09 |
| 10% CB | | | |
| EEA + 0.8% MWNT + | 8.87 | 17.7 | 5.2E+13 |
| 8% CB | | | |

The internal mixer compounding technique both permitted the making of carbon black and MWNT filled polymers with good accuracy regarding the conductive filler content. The viscosity of the MWNT filled compounds was much larger than those filled with VXC-500 carbon black at equivalent loading. At equal conductivity, the MWNT based compounds were also more viscous. The percolation threshold of the MWNT filled compounds was approximately 6 times lower than the VXC-500 carbon black filled compounds. That is interesting since the type of nanotube evaluated in the present work is not the best one as their purity was about 80% and that they are multi-wall and not single-wall. The latter are said to be much more effective in electrical conductivity. The nanotubes can act as a “bridge” to create electrical paths between the carbon black aggregates.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A polymeric composition comprising at least one thermoset polymer and single-wall carbon nanotubes.

2. (canceled)

3. (canceled)

4. The polymeric composition of claim 1, wherein the carbon nanotubes are purified carbon nanotubes.

5. The polymeric composition of claim 1, further comprising carbon black.

6. The polymeric composition of claim 1, wherein the polymer comprises an ethylene containing polymer.

7. The polymeric composition of claim 6, wherein the ethylene containing polymer is an ethylene ethyl acrylate copolymer.

8. The polymeric composition of claim 6, wherein the ethylene containing polymer comprises an ethylene ethyl acrylate copolymer, an ethylene vinyl acetate copolymer, an ethylene propylene rubber, an ethylene propylenediene monomer, or any combination thereof.

9. An article of manufacture formed, at least in part, from a composition comprising:
an ethylene containing polymer, single-wall carbon nanotubes, and a crosslinking agent, and wherein the article is a cable.

10. The article of manufacture of claim 9, wherein:
the ethylene containing polymer is present in an amount of from about 70% to about 99.95%, by weight, based on the total weight of the composition,
the carbon nanotubes are present in an amount of from about 0.05% to about 60%, by weight, based on the total weight of the composition,
the crosslinking agent is present in an amount of from about 1% to about 10%, by weight, based on the total weight of the composition.

11. The article of manufacture of claim 9, wherein the ethylene containing polymer is an ethylene ethyl acrylate copolymer.

12. The article of manufacture of claim 9, wherein the ethylene containing polymer is an ethylene ethyl acrylate copolymer, an ethylene vinyl acetate copolymer, an ethylene propylene rubber, an ethylene propylenediene monomer, or any combination thereof.

13. The article of manufacture of claim 9, wherein the composition is a semiconductive composition, and the article of manufacture is an electric cable comprising:
a metal conductor core;
a semiconductive shield;
an insulation layer;
an outer semiconductive layer; and
wherein the composition is utilized in at least one of the semiconductive shield or the outer semiconductive layer.

14. The article of manufacture of claim 13, wherein the composition is directly bonded to the insulation layer and the insulation layer comprises an ethylene homopolymer or copolymer.

15. A method of electrostatic painting an article comprising coating at least a portion of said article by electrostatic painting, wherein said article comprises a polymeric composition comprising at least one thermoset polymer and carbon nanotubes, wherein said polymer is a conductive polymer.

16. The polymeric composition of claim 5, wherein said carbon black has one or more of following characteristics:
CDBP (dibutyl adsorption value of the crushed carbon black): 30 to 700 cc per 100 grams of carbon black.
Iodine number: 15 to 1,500 mg/g.
Primary particle size: 7 to 200 nm.
BET surface area: 12 to 1,800 m²/g
DBP: 30 to 1,000 cc per 100 grams of carbon black.

17. An article comprising the polymeric composition of claim 1.

18. The article of claim 17, wherein said article is an automotive article.

19. The article of claim 17, wherein said article is an internal trim, a dashboard, a panel, a bumper fascia, a mirror, a seat fiber, a switch, a housing.

20. The article of claim 17, wherein said article is a finger trap safety system.

21. The article of claim 17, wherein said article is a pipe, profile, tube, tape, film, membrane, jacketing, components thereof, or fittings thereof.

22. The article of claim 17, wherein said article is a pressure pipe.

23. The article of claim 17, wherein said article is a fuel line.

24. The article of claim 17, wherein said article is an extruded article.

25. The method of claim 15, wherein the carbon nanotubes are single-wall carbon nanotubes.

26. An electrostatically painted article of the method of claim 15.

27. The electrostatically painted article of the method of claim 26, wherein the article is an automotive article.

28. An automotive article comprising a polymeric composition, wherein the polymeric composition comprising at least one thermoset polymer and carbon nanotubes.

29. The automotive article of claim 28, wherein said article is an internal trim, a dashboard, a panel, a bumper fascia, a mirror, a seat fiber, a switch, a housing, a finger trap safety system, or a fuel line.

30. A pressure pipe comprising a polymeric composition, wherein the polymeric composition comprising at least one thermoset polymer and carbon nanotubes.
